(19) United States
(12) Patent Application Publication
(10) Pub. No.: US 2008/0316350 A1
(43) Pub. Date: Dec. 25, 2008

(54) Image Acquisition System

(76) Inventors: Frank Gottwald, Weissach (DE); Werner Knee, Esslingen (DE); Jens Schick, Herrenberg (DE)

Correspondence Address: KENYON & KENYON LLP, ONE BROADWAY, NEW YORK, NY, 10004, US

(21) Appl. No.: 11/883,704

(22) PCT Filed: Feb. 8, 2006
(86) PCT No.: PCT/EP06/50773

§ 371 Date: Aug. 14, 2008

(30) Foreign Application Priority Data
Feb. 15, 2005 (DE) 102005006756.5

(51) Int. Cl. H04N 5/225

(52) U.S. Cl. 348/340; 348/E05.024

(57) ABSTRACT

An image acquisition system for use in a motor vehicle, and a method for manufacturing an image acquisition system, are provided. Image acquisition system encompasses an image sensor, an optical module, a housing and a carrier for the image sensor mounted on a circuit board. For the purpose of adjusting the image sensor and optical module, the carrier is movable in multiple axes and, after an optimum adjusted position is reached, is immobilizable therein with immobilization means.

### BACKGROUND INFORMATION

The present invention relates to an image acquisition system according to the preamble of claim 1. An imaging system of the species is preferably used in motor vehicles in order to obtain images of the vehicle's surroundings and, in combination with assistance systems, to make it easier for the driver to drive the vehicle. An image acquisition system of this kind encompasses at least one image sensor and an optical module, associated with that image sensor, that images onto the image sensor an acquired field of the image acquisition system from the vehicle's surroundings.

DE 199 17 438 A1 discloses a circuit assemblage and a method for manufacturing a circuit assemblage, the circuit assemblage encompassing a circuit board and an image sensor disposed thereon. Also proposed are an objective holder for the reception and mounting of optical elements. Instructions as to an image acquisition system having a simple configuration simultaneously with high accuracy in the image acquisition system are absent from DE 199 17 438 A1.

### ADVANTAGES OF THE INVENTION

The image acquisition system described below, in particular for use in a motor vehicle, is made up of at least one image sensor, an optical module, a housing, and a carrier that carries the image sensor and is adjustable as to its alignment within the housing, and is immobilizable in an adjusted position. Because the optical module is disposed in a manner integral with the housing but the image sensor, together with a circuit board, is disposed on the adjustable and immobilizable carrier, the optical module and the image sensor can initially be assembled separately from one another while observing relatively coarse tolerances. An exact adjustment of the image sensor and optical module, necessary for high quality in the image acquisition system, is achieved by alignment and subsequent immobilization of the carrier that carries the image sensor.

Advantageously, the optical module is disposed in a tube oriented centeredly onto the housing, a threaded receptacle being provided for reception of the optical module. A threaded receptacle offers many advantages: on the one hand, the optical module can be assembled easily and in accurately positioned fashion by threading it into the housing. The threaded receptacle furthermore offers the possibility of easily adjusting the image sharpness of the image sensor by threading the optical module in or out.

It is particularly advantageous that the image sensor is disposed on a circuit board, since this makes possible short signal and energy-supply paths to downstream electronic units. This advantageously contributes to a compact design of the image acquisition system. It is furthermore advantageous that the populated circuit board is disposed on an adjustable carrier that is immobilizable in an adjusted position, and is thereby positionable relative to the housing. The carrier is preferably fabricated from aluminum or an aluminum alloy. This also results in good mechanical stability and good vibration tolerance in the image acquisition system, which is thereby suitable in particular for use in motor vehicle engineering, i.e. for incorporation into a motor vehicle.

It is furthermore advantageous that as a function of image data of a test image projected by the optical module onto the image sensor, the image sharpness is adjusted by displacing the position, in the housing of the image acquisition system, of the carrier carrying the image sensor, since both alignment of the image sensor with respect to the optical module integral with the housing, and image sharpness, are thereby set in one manufacturing process.

It is particularly advantageous that as a function of the image data of the test image, at least one setting parameter of the image sensor, for example at least one setting parameter for intrinsic calibration and/or at least one setting parameter for fixed pattern noise correction, is ascertained and set as applicable, since thereby yet another setting operation is performed in an integrated manner in the context of manufacture of the image acquisition system. This advantageously results in a reduction in the manufacturing costs of the image acquisition system, while the image acquisition system at the same time exhibits high accuracy.

The aforementioned advantages for the image acquisition system also apply to a method for manufacturing an image acquisition system according to the present invention.

Further advantages are evident from the description below of exemplary embodiments with reference to the Figures, and from the dependent claims.

### DRAWING

The present invention will be explained in more detail below with reference to the embodiments depicted in the drawings, in which:

FIG. 1 shows an image acquisition of the preferred exemplary embodiment;

FIG. 2 shows a flow chart of the preferred exemplary embodiment.

### DESCRIPTION OF EXEMPLARY EMBODIMENTS

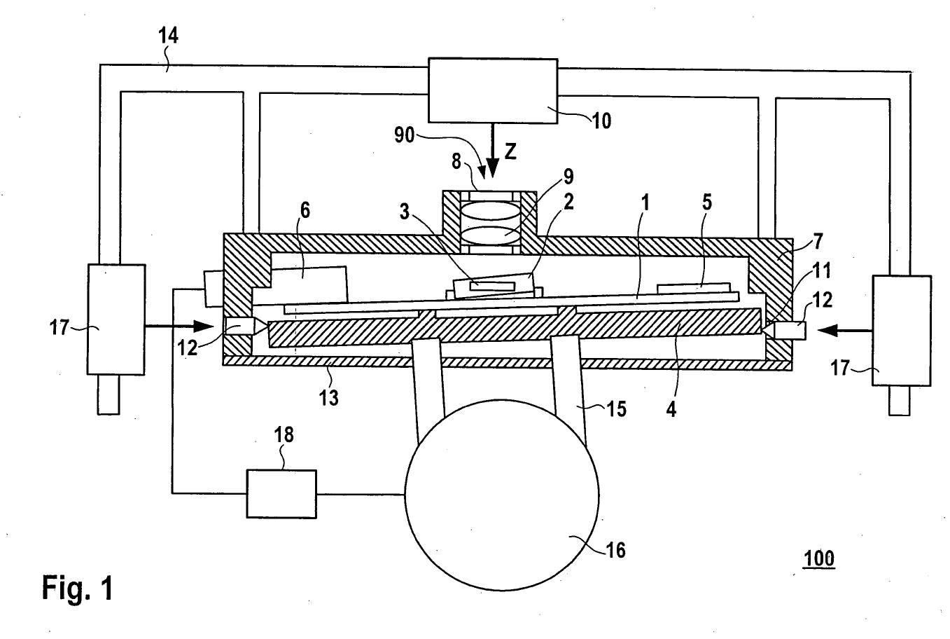

An image acquisition system in particular for use in a vehicle, a method for manufacturing such an image acquisition system, and a production device for manufacturing such an image acquisition system are described below with reference to the Figures. An image acquisition system provided for mobile use in a vehicle, in particular in a motor vehicle, must on the one hand be very robust so that it can withstand the rough operating conditions associated with motor vehicle operation. These operating conditions involve temperature resistance over a very wide temperature range, high shock resistance, splash resistance, and the like. At the same time, however, the image acquisition system also needs to be very accurate, and must image an acquisition region from the vehicle's surroundings in the sharpest and most detailed fashion possible, even under difficult viewing conditions. Simultaneously, however, the image acquisition system needs to be economically manufacturable in order to make utilization thereof attractive in large-scale vehicle production. High accuracy in the image acquisition system could occur, for example, thanks to extremely precise production of the components of the image acquisition system that are responsible for optical adjustment of the image elements. Such a solution can be achieved, however, only with additional design outlay. This possible approach is generally associated with elevated costs. Those costs would moreover be necessary only for the assembly operation, but not for operation of the image acquisition system. The invention therefore proceeds from the realization that an optically high-quality image acquisition system can be manufactured considerably more economically if comparatively coarse-tolerance components are optimally adjusted to one another in a high-precision production device, and then permanently immobilized in that adjusted position. Image acquisition system 100 depicted in FIG. 1 encompasses an image sensor 3 that, optionally surrounded by a transparent housing 2, is mounted on a circuit board 1. Image sensor 3 is mounted on circuit board 1 by means of known adhesives and/or by means of a soldering process that at the same time makes possible an electrical connection of the image sensor to the electrical and electronic components additionally disposed on circuit board 1. Also depicted, merely by way of example, are an electronic element 5 and a plug connector 6 that are likewise connected to circuit board 1. Because of the manner in which the present invention achieves its object, image sensor 3, or image sensor 3 optionally packaged in a housing 2, is mounted with relatively coarse tolerances on circuit board 1; this is useful in terms of economical production. In particular, it is not necessary for the light-sensitive surface of image sensor 3 already to be aligned parallel to the surface of circuit board 1. Circuit board 1 in turn is disposed on a carrier 4 that, for adjustment purposes, is supported movably in a housing 7, 13. In the preferred exemplary embodiment, carrier 4 is made of aluminum or an aluminum alloy. Housing 7, 13 is made up of a substantially cup-shaped base body 7 and a cover 13 that closes off base body 7. Disposed preferably centeredly in the bottom of housing 7 is a tube 8 that receives an optical module 90. Optical module 90 is made up of a combination of optical elements 9 that sharply image a scene from the acquisition region of image acquisition system 100 onto image sensor 3. Optical module 90 is thus operatively connected optically to image sensor 3. Optical module 90 and/or optical elements 9 of optical module 90 are disposed displaceably along at least one axis of housing 7, 13, preferably in the direction of the Z axis of housing 7, 13 that is perpendicular to the bottom of housing 7, 13, in order to enable focusing onto image sensor 3. Image acquisition system 100 furthermore encompasses immobilization means that make possible an immobilization of carrier 4 in an optimal adjusted position. Immobilization means 12 are preferably setscrews that at one end are braced against the inner wall of housing 7,13 and at the other end impinge with an applied force against carrier 4 on its outer periphery. In the preferred exemplary embodiment, immobilization means 12 have a tip, the tip exhibiting a greater hardness than the surface of carrier 4 against which the tips engage. Immobilization means 12 are preferably made of steel, the tips preferably being hardened. Upon immobilization, the tips of immobilization means 12 penetrate approximately one millimeter into the outer periphery of carrier 4. Immobilization means 12 are usefully supported in tapped holes in the wall of housing 7, 13, and are displaceable in the radial direction. Preferably at least three immobilization means 12 are provided which are disposed, distributed on the periphery of a circle, at an angular spacing of 120°. In a variant, four immobilization means 12 are provided, which engage on each side of a rectangular carrier 4. In a further variant, eight immobilization means 12 are provided, two immobilization means 12 engaging on each side of the rectangular carrier 4.

The assembly of image acquisition system 100 will be described below. In order to bring about assembly of image acquisition system 100 and, in that context, ensure optimum optical adjustment of image sensor 3 with respect to optical module 90, housing 7 is clamped into a receiving device 14 of an assembly device. The receiving device carries a plurality of screwing elements 10, 17. By means of screwing element 10, optical module 90 and optical elements 9 of optical module 90 are displaceable in the direction of the Z axis. By means of screwing element 17, immobilization means 12 are displaceable in the X-Y plane in the radial direction. The assembly device furthermore encompasses an automatic production machine, in particular a robot, having a gripper arm 15 that makes possible shifting of a grasped workpiece in the X-Y plane, and rotation of the workpiece about the X, Y, and Z axes. Carrier 4 is provided as the workpiece to be handled by gripper arm 15. Carrier 4 mounted on gripper arm 15, having circuit board 1 mounted on carrier 4 and image sensor 3 disposed on circuit board 1, is introduced into the interior of housing 7, 13 and aligned, by motions of gripper arm 15 in the X and Y direction controlled by robot 16, and by tilting motions about the X, Y, and Z axes, onto optical module 90. For that purpose, image sensor 3 is usefully illuminated with a test image that is projected by optical module 90 onto the light-sensitive surface of image sensor 3. Focusing is accomplished in this context by displacement of optical module 90 in the Z direction by way of screwing element 10. Once an optimum adjusted position has been reached, adjustment means 12 are rotated by screwing element 17 in such a way that they move out in the radial direction toward the center of housing 7, 13 and clamp carrier 4 between them. The tips of immobilization/adjustment means 12 thereby penetrate approximately one millimeter into carrier 4. Thus secures in place an optimum optical adjusted position once it has been set. In the preferred exemplary embodiment, immobilization means 12 are tightened simultaneously, and the screwing torque is monitored. The position of image sensor 3 with respect to optical module 90 is also monitored, and the individual immobilization means 12 are tightened in such a way that the position of image sensor 3 with respect to optical module 90 remains unchanged, or is at least located within a defined tolerance range. Immobilization means 12 are then secured, using adhesive and/or a thread locker, to prevent unscrewing. After detachment of gripper arm 15 from carrier 4 clamped in housing 2, housing 2 is closed off with cover 13. Image acquisition system 100 that has been completed in this fashion is then removed from receiving device 14.

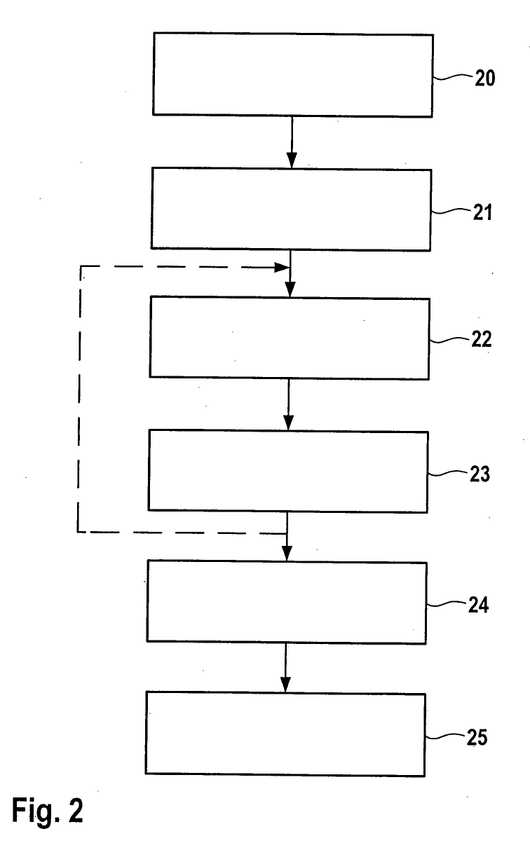

FIG. 2 shows, in a flow chart, essential steps of the method for manufacturing an image acquisition system 100 according to the preferred exemplary embodiment of FIG. 1. The flow chart according to FIG. 2 is limited to the steps that relate to optical adjustment of image sensor 3 and of optical module 90. Among the actions that occur before these steps are installation of optical module 90 in housing 7, mounting of image sensor 3 on circuit board 1, and mounting of circuit board 1 on carrier 4. In a first method step 20, housing 7 is introduced into receiving device 14 and immobilized therein. In the next step 21, carrier 4, together with circuit board 1 mounted thereon and image sensor 3 mounted on circuit board 1, are introduced by means of gripper arm 15 into housing 7. In a third step 22, the optical axes of optical module 90 and of image sensor 3 are brought into congruence. This is usefully accomplished by corresponding shifts of carrier 4 in the X and Y directions, and by tilting motions, necessary as applicable, of carrier 4 about the X, Y, and Z axes. The necessary motions are carried out by gripper arm 15 of automatic production machine 16. Alignment of the optical axes of optical module 90 and of image sensor 3 is usefully accomplished with the aid of a test image that is projected by optical module 90 onto image sensor 3. An evaluation device, labeled with reference character 18 in FIG. 1, senses output signals of image 3 and conveys corresponding control signals to automatic production machine 16. In a next step 23, the test image projected by optical module 90 onto image sensor 3 is focused under the control of evaluation device 18. This is accomplished by the fact that screwing element 10, equipped with a matching tool, engages into the mount of optical module 90 and displaces optical module 90 in the Z direction by way of a screwing motion. Optionally, method steps 22 are iteratively repeated until the desired alignment accuracy is achieved. In a subsequent method step 24, carrier 4 is immobilized in the optimum immobilized position achieved in the previously described steps, by the fact that immobilization means 12 are displaced by screwing element 17 in the radial direction in such a way that they clamp carrier 4 between them. In the preferred exemplary embodiment, immobilization means 12 are tightened simultaneously, and the screwing torque is monitored. The position of image sensor 3 with respect to optical module 90 is moreover monitored, and the individual immobilization means 12 are tightened in such a way that the position of image sensor 3 with respect to optical module 90 remains unchanged or at least is located within a defined tolerance range. Adjustment of the screwing torque, and thus monitoring of the position of image sensor 3 with respect to optical module 90, are carried out by evaluation device 18 as a function of the test image projected by optical module 90 onto image sensor 3. Immobilization means 12 are then secured, using adhesive and/or a thread locker, to prevent unscrewing. In the subsequent method step 25, at least one further setting parameter of image sensor 3, for example at least one setting parameter for intrinsic calibration and/or at least one setting parameter for fixed pattern noise correction, is ascertained as a function of the image data of the test image, and adjusted as applicable. Further method steps that once again are not depicted here in detail relate to the detachment of gripper arm 15 from carrier 4, the displacement of housing 2, 13 with cover 13, and the removal from receiving device 14 of the completed image acquisition system 100. Image acquisition system 100 that has been described, and the method for manufacturing an image acquisition system, are suitable for CCD image sensors and/or CMOS image sensors. A production device that is particularly suitable for the manufacture of image acquisition system 100 encompasses a receiving device 14 for receiving a housing 7 of image acquisition system 100. The production device furthermore encompasses various screwing elements 10, 17 that enable an adjustment of optical module 90 and a displacement of immobilization means 12. Lastly, the production device also encompasses an automatic production machine 16 having a gripper arm 15 that permits motion of a component (carrier 4) of image acquisition system 100 about at least five axes.

In a variant of the preferred exemplary embodiment, the immobilization means are disposed in tapped holes in the carrier and are once again displaceable in the radial direction. In this variant, the immobilization means engages into elements, located inside the carrier, that are attached to the housing. Preferably once again three immobilization means are provided which are disposed, distributed on the periphery of a circle, at an angular spacing of 120°. In a variant, four immobilization means are provided, which are located on each side of a rectangular carrier. In a further variant, eight immobilization means are provided, two immobilization means being disposed on each side of the rectangular carrier. The image acquisition system is otherwise constructed substantially identically to the image acquisition system of the preferred exemplary embodiment according to FIG. 1. Manufacturing also corresponds substantially to the preferred exemplary embodiment according to FIG. 2. The disadvantage of this variant is that the positions of the heads of the immobilization means change during alignment. The advantage, however, is that the configuration of the image acquisition system can be more compact.

1-18. (canceled)

19. An image acquisition system, comprising:
a housing;
an optical module disposed in the housing; and
at least one image sensor operatively connected optically to the optical module;
wherein the at least one image sensor is configured to be: a) adjustable with respect to the optical module; and b) fixed in an adjusted position, after being adjusted.

20. The image acquisition system as recited in claim 19, wherein the optical module is attached to the housing.

21. The image acquisition system as recited in claim 19, wherein one of a) the optical module and b) an optical element of the optical module is configured to be displaceable in at least one axis of the housing.

22. The image acquisition system as recited in claim 21, wherein the at least one image sensor is disposed on a circuit board.

23. The image acquisition system as recited in claim 22, wherein the circuit board is mounted on a carrier.

24. The image acquisition system as recited in claim 23, wherein during an adjustment operation, the carrier is displaceable in at least one plane and rotatable about at least three axes, and wherein the carrier is configured to be fixed to the housing in a final position after the adjustment operation.

25. The image acquisition system as recited in claim 23, further comprising:
an immobilization arrangement, wherein the immobilization arrangement is a) braced on the housing and b) engaged with the carrier on a periphery of the carrier, whereby the immobilization arrangement fixes the carrier to the housing.

26. The image acquisition system as recited in claim 25, wherein the immobilization arrangement includes setscrews that are supported in tapped holes disposed in a side wall of the housing, and wherein the setscrews are displaceable in a radial direction.

27. The image acquisition system as recited in claim 25, wherein the immobilization arrangement includes a tip that engages the carrier, and wherein the tip is harder than a surface of the carrier engaged by the tip.

28. The image acquisition system as recited in claim 25, wherein the carrier is made of at least one of aluminum and aluminum alloy.

29. The image acquisition system as recited in claim 25, wherein the image acquisition system is incorporated in a vehicle.

30. A method for manufacturing an image acquisition system, comprising:
providing an optical module in a housing, wherein the optical module is fixed to the housing;
providing an image sensor which is operatively connected optically to the optical module, wherein the image sensor is mounted on a circuit board, and wherein the circuit board is mounted on a carrier;
introducing the carrier into the housing by an automatic production machine;
aligning the carrier in the housing in such a way that the image sensor and the optical module are adjusted to one another; and
fixing the carrier in an adjusted position in the housing, using an immobilization arrangement.

31. The method as recited in claim 30, wherein the optical module and the image sensor are optically adjusted to one another, and wherein the optical adjustment is accomplished with the aid of a test image that is projected by the optical module onto the image sensor, and wherein output signals of the image sensor are generated such that the output signals are sensed by an evaluation device and conveyed to the automatic production machine.

32. The method as recited in claim 31, further comprising:
ascertaining at least one setting parameter of the image sensor as a function of image data of the test image projected onto the image sensor, wherein the at least one setting parameter includes at least one of a setting parameter for intrinsic calibration and a setting parameter of fixed pattern noise correction.

33. The method as recited in claim 30, wherein the position of the image sensor relative to the optical module is monitored in the context of fixing the carrier in the adjusted position.

34. The method as recited in claim 33, wherein the monitoring is accomplished with the aid of a test image that is projected by the optical module onto the image sensor, and wherein output signals of the image sensor are generated such that the output signals are sensed by an evaluation device and conveyed to the automatic production machine.

35. A production apparatus for producing an image acquisition system, wherein the image acquisition system includes a housing, an optical module and an image sensor, the apparatus comprising:
a receiving device for the housing of the image acquisition system;
screwing elements acting in an axial and a radial direction, wherein the screwing elements are configured to displace the optical module in the Z-direction and displace an immobilization arrangement for a carrier of the image sensor in a radial direction; and
an automatic production machine including a gripper arm that is controllable about at least five axes, wherein the automatic production machine is configured for adjustment of the carrier carrying the image sensor, relative to the optical module.

36. The production apparatus as recited in claim 35, further comprising:
an evaluation device, wherein the image sensor receives a test image, and wherein output signals of the image sensor are transmitted to an input of the evaluation device, and wherein an output of the evaluation device is connected to the automatic production machine for adjustment of the carrier.
